(19) United States
(12) Patent Application Publication
(10) Pub. No.: US 2017/0309124 A1
(43) Pub. Date: Oct. 26, 2017

(54) SYSTEM FOR IDENTIFYING AND REPORTING MOST CHOSEN PATH WIN IN LOTTERY GAMES

(71) Applicant: Stephen E. Wade, Olympia, WA (US)

(72) Inventor: Stephen E. Wade, Olympia, WA (US)

(73) Assignee: Lottery Management Consulting, LLC, Olympia, WA (US)

(21) Appl. No.: 15/649,050

(22) Filed: Jul. 13, 2017

Related U.S. Application Data
(63) Continuation-in-part of application No. 14/637,298, filed on Mar. 3, 2015.

(51) Int. Cl. G07F 17/32

(52) U.S. Cl. CPC G07F 17/3262; G07F 17/329; G07F 17/3225; G07F 17/3244

(57) ABSTRACT

A method comprising: receiving, over a network, wager information for a plurality of wager items, from a plurality of players, the wager item being a selection from some of several choices, then choosing at random a winning selection from the several choices, then continuing similar wager items for a plurality of rounds, and then awarding a prize to those players who, over all of the rounds, have selected at least a certain number of winning selections. The method further includes recording by player each player's selection for each round, aggregating data for the completed selection order of each player after all the rounds, this data being the path chosen by the player, and the selection order being the selection chosen after a given prior selection. The method then awards a prize in equal shares to those players who, over all the rounds, have selected the path chosen by a larger number of players.

### RELATED APPLICATION

This application is a continuation-in-part application of Wade U.S. patent application Ser. No. 14/637,298 filed Mar. 3, 2015, Incorporated herein by reference in its entirety.

### FIELD OF THE INVENTION

This disclosure relates to a gaming method comprising receiving, over a network, wager information tor a plurality of wager items, from a plurality of players, the wager item being a selection from some of several choices, then choosing at random a winning selection from the several choices.

More particularly, this method defines a type of winning event in a lottery game, and the means for identifying the players who participate in this winning event.

### SUMMARY OF THE INVENTION

Disclosed is a method comprising: receiving, over a network, wager Information for a plurality of wager items, from a plurality of players, the wager item being a selection from some of several choices, then choosing at random a winning selection from the several choices. The method further comprises the steps of then continuing similar wager items for a plurality of rounds, then awarding a prize to those players who over all of the rounds, have selected at least a certain number of winning selections.

The method further includes recording player each player's selection for each round, aggregating data for the completed selection order of each player after all the rounds, this data being the path chosen by the player, and the selection order being the selection chosen after a given prior selection. The method then awards a prize in equal shares to those players who, over all the rounds, have selected the path chosen by a larger number of players.

In one embodiment, the method further comprises transmitting the updated aggregate player action data to the plurality of players.

In one embodiment, the method includes the step of aggregating data for completed selection orders after each round, then displaying this aggregated data after each round to the players.

In one embodiment, players are eligible to share the prize for one of the paths chosen by a larger number of players, after making a wager different from the wager for having selected at last a certain number of winning selections.

This innovation might be called “paying the most popular choice”. It requires the lottery to incur an additional prize liability, and to pay it pari mutual, in equal shares, to the most-bet-upon of all the choices available in the game.

To practice the “most chosen path method”, the lottery defines the “most chosen path” as that path chosen by the greatest number of players, and pays equally to each player who chooses this path a certain portion of the value of wagers in the game. That is, the prize fund for this “most chosen path” win is distributed in a pari mutuel way, regardless of how other prizes may be defined.

### BRIEF DESCRIPTION OF THE DRAWINGS

FIG. 1 is schematic illustration of the game according to this disclosure.

### DETAILED DESCRIPTION

This game is played stepwise that is, the outcome of the first round is known before the second round begins, with the players arid the lottery ‘taking turns’ at selecting their symbols. Players choose according to their best judgment; the lottery chooses strictly at random. The game is social in the sense that as each round is completed, the lottery may provide, to all players, some information on the choices that have been made. For convenience, we refer to the choices made in sequence as a “path”. In particular, the lottery identifies the most popular path and the number of plays on it; the lottery also identifies, for each individual player, the number of plays on that player's path. After the first round, the choices potentially made by players define three paths, after the second round, nine paths, and so on, until after the seventh round a full set of 3̂7 or 2187 potential paths is defined. If 9,000 players are playing the game, the most popular path will have something more than 3000 plays after the first round, more than 1000 after the second and so on. After seven rounds, some of the potential paths may in fact have no plays, and some may have several. Through each round the lottery may provide information on the most popular path, and also the path the player happens to have played.

At the start of the game, every player is a potential winner of the top prize, and also of the “most popular path” prize. As the game progresses, some players will lose some rounds. Many will arrive at a point where, even if they were to win ail remaining rounds, they will have lest more rounds than they won. At this point, these players are contenders only for the most popular path prize. However, the identity of that path will not be certain until after the last round is played. Nor is it certain that the path most chosen after round six will be extended to produce the seventh-round winner. Defining a prize for the most chosen path thus supports keeping players engaged until the end of the game. This adds to the entertainment value of the game. This in turn supports the lottery's objective of selling more wagers.

Calculations suggest that a relatively small contribution from each wager could supply a significant prize for each player on the most chosen path, if players make their choices at random. However, players are not likely to make truly random choices, and once they understand the nature of this prize, they may adjust their play to try to win it. Individual players might place multiple wagers on the same path. Multiple players might organize among themselves to keep to the same path. Far from playing randomly, players may play systematically. These tactics, singly or in combination, may sometimes be effective in defining the most chosen path. However, the tactics of one set of players can always be defeated by a slightly larger or more avid set of players, or by the random accretion of plays to a particular path. Thus, while defining a prize for the most chosen path introduces an incentive for socially coordinated play, it does not change the fundamentally chance nature of the winning outcomes.

Further, to the extern that tactics of systematic play put more wagers on the most popular path, they dilute the size of the prize payout to each wager. As the number of wagers on the most popular path climbs, a point may be reached where the pari mutual value of the prize is not greater than the wager. At this point any positive benefit of the win is small. This disclosure proposes recognizing this in a game rule that that basically says “no prize less than the wager”. When the pari mutual win would be less than the wager, the lottery could elect not to pay any choice, or to pay a choice identified on some other basis. Introducing the possibility that too many wagers could be made on the most popular choice gives players even more reason to be aware of what others are doing, and potentially increases their engagement with the social aspect of the game.

The discussion above is predicated on the idea that every wager in the game is potentially eligible to be paid a prize if it corresponds to the most popular choice, and that the lottery sets aside a small portion of the revenue from each wager to pay this prize. Potentially more advantageous to the lottery and more interesting for the player, would be an alternative wherein the most popular choice prize is an extra-cost option—players who play the “base” game (Rock, Paper, Scissors in the example above) could elect to pay an additional consideration in order to be eligible to share in the most popular choice prize, which would be funded from that additional consideration. This could result in extra revenue for the lottery, and fund bigger prizes for the most popular choice. Funding the most popular choice win as an extra-cost option would make invoking the “no prize less than wager” rule less likely.

It may be in the lottery's interest to maintain a level of uncertainty about which path will be paid the “most chosen” prize, even if playing for this prize in a coordinated way becomes popular. To this end the Lottery could define a game rule to pay at random one of the “N most popular” paths, rather than to pay the singular most popular path with certainty. Likewise, the lottery could maintain some ambiguity in the information it feeds back to players after each round, as by communicating ranges rather than precise counts of plays.

Implementing this innovation would require a system capable of tracking the actions taken by all players at each step, reporting aggregate features of these actions potentially to each player at each step, and recognizing the path to be paid and the pari mutuel share clue to each wager at the end of the game.

Although the innovation is described with reference to lottery games, it could be practiced in a gambling establishment of any scale.

Practicing this method requires a system for tabulating the number of players on each path, ranking the paths to identify the one most chosen, calculating the share of the available prize fund to be apportioned to each player on that most chosen path, and reporting this information out to players instantly such that the value of any such win is known without delay.

If this method is practiced along with the “stepwise, social lottery games” method according to the Wade U.S. patent application Ser. No. 14/837,298 filed Mar. 3, 2015, the lottery may evaluate arid report on the most chosen path after any step. However, the “most chosen path” win can also be practiced with a single report at the end of the game.

This method has utility for the lottery because it provides an incentive for players to communicate and play in a coordinated way, and even to recruit people to play a particular path, in an effort to capture and share the “most chosen path” win. This is novel and non-obvious within the art of lottery games, wherein wins are identified by some function unrelated to the number of wagers on any particular outcome. In fact, fact, the need to share among a number of participants making the same wager the value of a win determined by traditional means, as in previous lottery games with pari mutuel division of prizes, provides a dis-incentive to coordinated play. The present method incentivizes coordinated and social play, and thereby promotes increased volume of play. Since the win is defined pari mutuel, formation of very large syndicates of players in order to capture the “most chosen path” win is futile; the effective scale of coordination is consistent with casual social interaction.

In one embodiment, this prize is a feature of games that begin periodically. In some lottery jurisdictions and in casinos, the game called Keno typically runs at 4 minute Intervals. Players typically buy a Keno ticket for the “next” draw, or for the drawing scheduled at a particular time, or for the next N drawings.

If “Rock, Paper, Scissors” (R, P, S); were running at 4 min intervals between draw events, I would expect that each player would have to pay and make a first choice in time for the start of the lottery's draw sequence. The seven rounds of play would then follow at some set schedule, perhaps 10-15 seconds. During the interval between lottery draws, the lottery would push out information and receive the players' next choices. The information pushed out might say “the most popular path is (for example) RPS and there are 567 plays on it; your path RPP has 540 plays on it.” The information shared with the players might also include the size of the prize pool to be split among the eventual winners of the most chosen path prize.

If a player drops communication with the lottery before completion of the game, the “last” choice R, P, or S would be used for the remaining rounds. Various other features of this disclosure are set forth in the following claims.

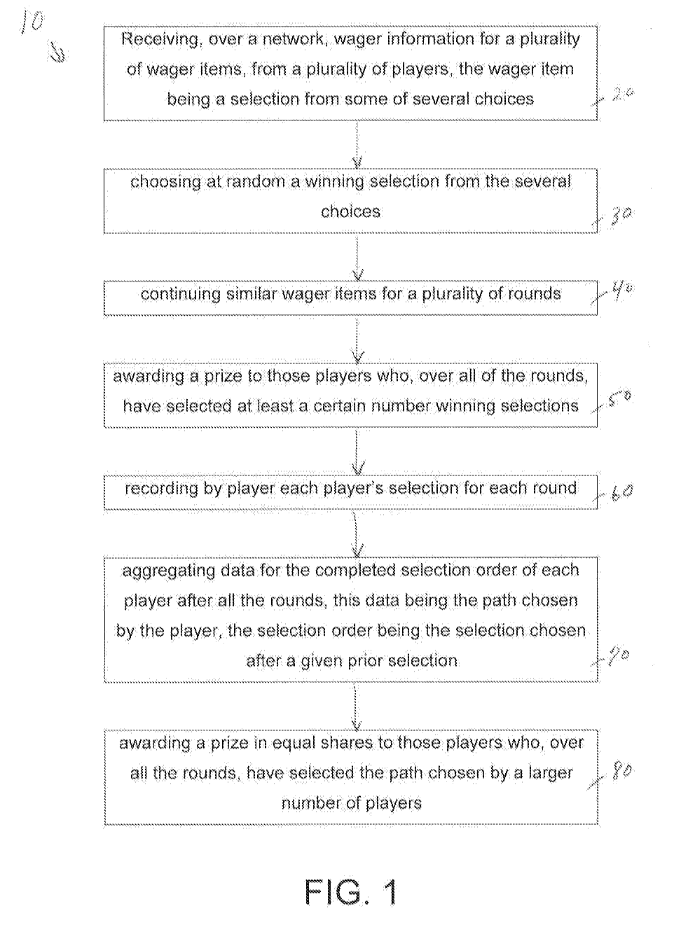

In summary then, as illustrated in FIG. 1, the game 10 comprises the steps of: 20 receiving, over a network, wager information for a plurality of wager items, from a plurality of players, the wager item being a selection from some of several choices, then 30 choosing at random a winning selection from the several choices, then 40 continuing similar wager items for a plurality of rounds, then 50 awarding a prize to those players who, over all of the rounds, have selected at least a certain number winning selections, then 60 recording by player each player's selection for each round, then 70 aggregating data for the completed selection order of each player after all the rounds, this data being the path chosen by the player, the selection order being the selection chosen after a given prior selection, then 80 awarding a prize in equal shares to those players who, over all the rounds, have selected the path chosen by a larger number of players,

Various other features of this disclosure are set forth in the following claims.

1. A gaming method comprising: receiving, over a network, wager information for a plurality of wager items, from a plurality of players, the wager item being a selection from some of several choices, then
choosing at random a winning selection from the several choices, then
continuing similar wager items for a plurality of rounds, then
awarding a prize to those players who, over all of the rounds, have selected at least a certain number of winning selections,
recording by player each player's selection for each round,
aggregating data for the completed selection order of each player after all the rounds, this data being the path chosen by the player, the selection order being the selection chosen after a given prior selection, then
awarding a prize in equal shares to those players who, over all the rounds, have selected the path chosen by a larger number of players.

2. The gaming method of claim 1, further comprising transmitting the updated aggregate player action data to the plurality of players.

3. The gaming method of claim 1, wherein the method includes the step of aggregating data for completed selection orders after each round, then
displaying this aggregated data after each round to the players.

4. The gaming method of claim 1, wherein being eligible to share the prize for one of the paths chosen by a letter number of players requires a wager different from the wager for having selected at last a certain number of winning selections.

5. The gaming method of claim 1, wherein one selection is chosen from three possible selections.
